(19) United States
(12) Patent Application Publication
(10) Pub. No.: US 2011/0148113 A1
(43) Pub. Date: Jun. 23, 2011

(54) VIBRATION DAMPING OF WIND TURBINE SHAFT

(75) Inventors: Huaizhong Li, Singapore (SG); Saravana Ranganathan Damodaran, Singapore (SG); Srikanth Narasimalu, Singapore (SG)

(73) Assignee: VESTAS WIND SYSTEMS A/S, Randers SV (DK)

(21) Appl. No.: 12/971,376

(22) Filed: Dec. 17, 2010

Related U.S. Application Data
(60) Provisional application No. 61/287,502, filed on Dec. 17, 2009.

(30) Foreign Application Priority Data
Dec. 17, 2009 (DK) PA 2009 70278

(51) Int. Cl. H02P 9/04

(52) U.S. Cl. 290/44

(57) ABSTRACT

A damper which effectively dampens vibrations experienced by a shaft in a drive train of a wind turbine generator, such as a main shaft of the WTG, is disclosed. The damper includes a vibration sensor adapted to provide a vibration signal in response to the vibrations of the shaft, an electromagnet adapted to provide an electromagnetic force to the shaft, and a controller operably coupled to the vibration sensor and the electromagnet. The controller is adapted to generate command signals to provide a suitable drive current to the electromagnet in response to the vibration signal, and the electromagnet is adapted to provide an electromagnetic force to the shaft and thereby actively dampen the vibrations of the shaft.

### CROSS-REFERENCE TO RELATED APPLICATIONS

This application claims priority under 35 U.S.C. §119(a) to Danish Patent Application No. PA 2009 70278, filed Dec. 17, 2009. This application also claims the benefit of U.S. Provisional Application No. 61/287,502, filed Dec. 17, 2009. Each of the applications is incorporated by reference herein in its entirety.

### TECHNICAL FIELD

The invention relates to damping of vibrations of a WTG (Wind Turbine Generator) shaft and a vibration damper for such shaft.

### BACKGROUND

A WTG is used to gather wind energy and to transform the wind energy into another form of energy. For this purpose, most wind turbines include a main shaft which in one end is coupled to blades of the WT (Wind Turbine). Normally the opposite end of the main shaft is connected to a driven wind turbine part. This driven wind turbine part may be an entrance shaft of a gearbox or an entrance shaft of an electric energy generator.

Wind turbine generators are subject to loads due to the wind. In consequence, the main shaft also experiences loads due to the wind but also due to other factors, such as a resistance against rotation of the shaft provided by the generator and/or due to the gearbox and/or friction in shaft bearings.

These loads may cause disadvantageous vibrations in a drive train of the WTG, which drive train may comprise one or more of the following parts of the WTG: the main shaft, main shaft bearings, any additional shafts connected to the main shaft, the gearbox and the generator as well as any other shafts or connecting members for transferring torque.

Vibrations in the main shaft of the wind turbine may in consequence cause a disadvantageous increase in wear on one or more components in the drive train. Possibly such wear causes a decrease in the lifetime of the one or more parts in the drive train. Still further, the vibrations may be audible and thus create undesired noise.

According to the present inventors, reference systems fail to provide a damper for damping vibrations of a WTG shaft and a method of damping vibrations in a WTG shaft, which damper and method are able to effectively suppress vibrations experienced in the WTG shaft. In consequence, the present invention has been devised.

### SUMMARY

Embodiments of the present invention provide an improved vibration damper for damping vibrations of a WTG shaft and an improved method of damping vibrations in the shaft of a WTG. Preferably, aspects of the invention alleviate, mitigate or eliminate one or more of the above or other disadvantages singly or in any combination.

Further, various embodiments provide a damper of a WTG shaft and a method of damping vibrations of a WTG shaft, which damper and method is particularly beneficial to damping vibrations which are a consequence of the loads experienced by the WTG, among others due to the wind.

Still further, various embodiments provide a damper of a WTG shaft and a method of damping vibrations of a WTG shaft, which damper and method can be applied to new wind turbine generators, but which may just as effectively be applied to existing wind turbine generators.

Accordingly there is provided, in a first aspect, a vibration damper for damping vibrations of a WTG shaft, the damper including

at least one vibration sensor adapted to provide a vibration signal in response to the vibrations of the shaft, and

at least one electromagnet adapted to provide an electromagnetic force to the shaft, and

a controller operably coupled to the electromagnet and adapted to generate a command signal in order to provide a drive current for the electromagnet in response to the vibration signal and in order for the electromagnet to provide an electromagnetic force to the shaft and hereby dampen the vibrations of the shaft.

It follows that the vibration signal is provided as an input to the controller and/or to a device, such as an amplifier, coupled to the controller and electromagnet in an operatively working manner, in order to provide the drive or excitation current to the electromagnet. The controller is adapted to vary the command signals in response to the vibration signal, which may be varying, and in accordance with a control scheme of the controller.

Thus, an improved vibration damper for actively damping vibrations of a WTG shaft is provided. The improvement may lie therein that by actively damping vibrations as described, a damper which effectively dampens vibrations which are a consequence of the loads experienced by the WTG due to the wind is provided.

An advantage of the damper may alternatively or additionally lie therein that the damper as described may be used in conjunction with, or as a simple add-on to, mechanical bearings for the shaft, which mechanical bearings transfer all, or at least a main part of bending moments, etc. from the shaft to a supporting structure, whereas the damper is used to generate a magnetic force, such as a Lorenz force, to the shaft to suppress its vibration. In such a damper arrangement, the electromagnetically based active damping system is relatively cheap, simple, and easy to implement on existing and new wind turbine generators, while the damper and method of damping as described herein can provide significant vibration damping effects to a shaft of the wind turbine generator and thereby to the drive train of a wind turbine.

A still further advantage of the damper and method of vibration damping as described herein may lie therein that, for example, a short power dropout to the vibration damper will not cause harm to the normal operation of the WTG main shaft.

In accordance with an embodiment of the invention the damper includes at least two electromagnets, and the electromagnets are positioned 90 degrees or substantially 90 degrees from each other. When more than four electromagnets are provided around the shaft, e.g., 8 electromagnets, and the magnets are, as an example, evenly distributed around the periphery of the shaft, an angle or angular pitch between each electromagnet decreases from 90 degrees. Alternatively, the damper comprises at least one pair of two electromagnets and the two electromagnets in the pair are positioned 180 degrees or substantially 180 degrees from each other. A plurality of electromagnets, such as 3, 4, 8, 16 or 32, may be positioned around the shaft to improve a resolution of a resulting direction in which the electromagnetic force, provided by the electromagnets, can be provided to the shaft. Among the plurality of electromagnets there may be one or more pairs of oppositely positioned electromagnets.

The vibration damper may include at least one dual pole electromagnet. A possible advantage hereby is that a ferromagnetic shaft or a ferromagnetic material or layers of ferromagnetic material attached to the shaft can be used in cooperation with such electromagnets.

When adjacent poles of individual dual pole electromagnets are arranged with opposite polarity, a possible advantage is that a magnetic flux through the rotating shaft, and thus a magnetic force provided by the electromagnet to attract the shaft towards the electromagnet, can be maximized.

When the at least one electromagnet is a single pole electromagnet, a possible advantage is that such electromagnet can be used in cooperation with a permanent magnetic shaft or a shaft provided with a permanently magnetic material to attract or push the shaft.

In accordance with a second aspect of the invention there is provided a method of actively damping vibrations in a shaft of a WTG, the method comprising

sensing vibrations of the shaft and providing a vibration signal in response to the vibrations, and

providing command signals in response to the vibration signal in order to provide a drive current for the electromagnet in response to the vibrations, and hereby

applying an electromagnetic force to the shaft with the electromagnet and in response to the vibration signal, and

damping the vibrations of the shaft by applying the electromagnetic force to the shaft.

Possible advantages of this method of damping vibrations in a shaft of a wind turbine and/or of the damper as described herein, when compared with reference dampers, include one or more of the following advantages: reduced down time of the WTG, less wear to the bearings, improved life of shaft and bearings, reduced maintenance costs or minimised environmental noise pollution due to the reduced vibration level.

In a third aspect, the invention relates to a computer program product, when running on a computing device, such as the controller as described herein, being adapted to perform the method of actively damping vibrations of a WTG shaft as described herein.

It must be understood that any advantage mentioned may be seen as a possible advantage provided by the invention, but it may also be understood that the invention is particularly, but not exclusively, advantageous for obtaining the described advantage. In general the various aspects and advantages of the invention may be combined and coupled in any way possible within the scope of the invention.

These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which:

FIG. 1 shows a wind turbine (WT);

FIG. 2 is a side view of a hub and a nacelle of the WT comprising a drive train and an active vibration damper;

FIG. 3 is an illustration of the drive train of the WT including the active vibration damper;

FIG. 4 is an illustration of an embodiment of a vibration damper with single pole electromagnets;

FIG. 5 is an illustration of an embodiment of a vibration damper with dual pole electromagnets;

FIG. 6 is an illustration of an embodiment of a vibration damper; and

FIG. 7 is an illustration of a method of actively damping vibrations in a shaft of a WTG.

### DETAILED DESCRIPTION

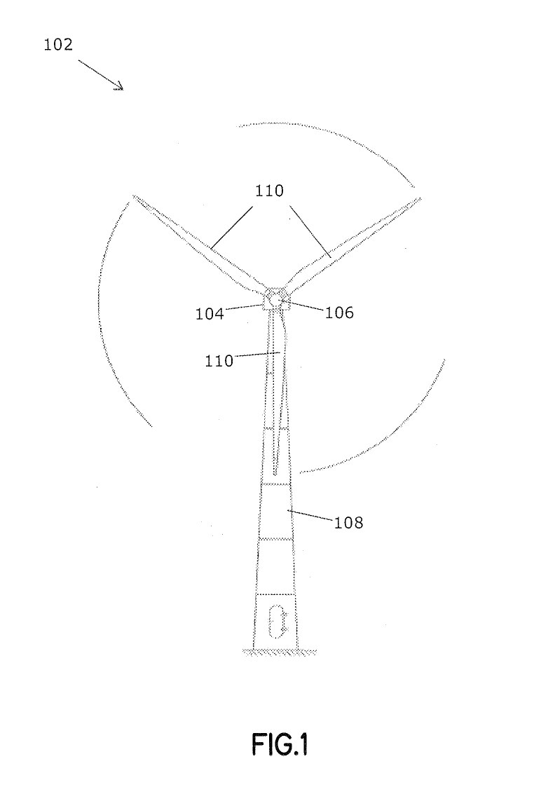

FIG. 1 shows a wind turbine 102 with a nacelle 104. Blades 110 are mounted to a hub 106 (not visible), which hub is rotatably mounted to the nacelle 104 via a main shaft (not seen in FIG. 1). The hub interconnects the three blades. The nacelle 104 is mounted on a wind turbine tower 108 via a rotary joint. When the blades are subjected to wind load, the shaft rotates around a centre axis of the main shaft.

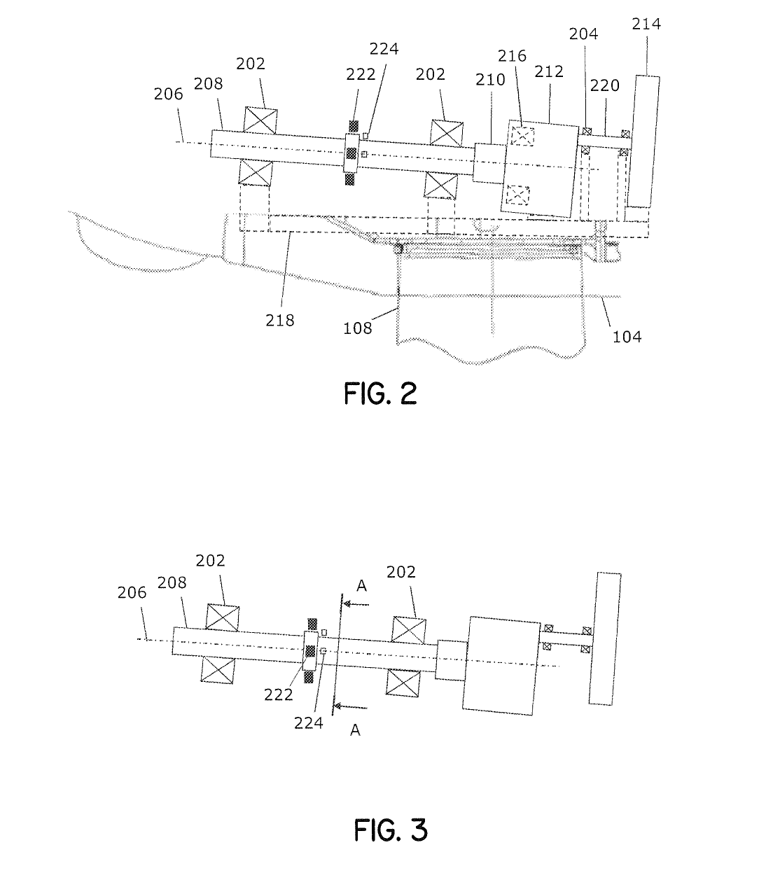

FIG. 2 is a side view showing a part of the nacelle 104. The figure is an illustration of a drive train 304 in a WT. Some parts inside the nacelle, such as bearings 202 and 204 for the shafts 208 and 220 are shown in cross-section. The figure illustrates the centre axis 206 of the main shaft running in a longitudinal direction in a centre of the main shaft 208.

The figure illustrates two bearings 202 provided for bearing the main shaft 208 and for transferring bending moments from the main shaft to the tower 108 and transferring torque to a gearbox 212 and/or a generator 214. One or more additional bearings 216 may also be provided. In the shown embodiment, the two bearings 202 are shown and used as bearing for the main shaft, but alternatively only one of these bearings, such as a frontmost of these two bearings 212, may be provided, and the additional bearing 216, such as a bearing in connection with the gearbox or a generator, may alternatively be used.

As an example, the bearings 202 may be provided as mechanical bearings such as roller element bearings and/or as journal bearings. The shaft may be provided with a form which also enables one or more of the bearings able to transfer forces in the longitudinal direction of the shaft, via bearings suitable for such forces, and into the support structure 218.

In an end of the main shaft opposite to the hub, the main shaft is connected to an entrance shaft 210 of the gearbox 212. It follows from the figure that the main shaft 208 is a relatively large shaft, which may have a diameter in an interval of 0.5-1.5 meter and a length possibly within an interval of 3-8 meter. The main shaft of a wind turbine generator has a low rotation speed, such as below 45 rpm, such as in the interval between 5 and 35 rpm, such as in the interval between 15 and 25 rpm.

The shaft is provided with these dimensions and in a suitable material and manner, among other things, in order to transfer bending moments from the hub with the WT blades to the support structure 218 and further into the tower 108 and to transfer torque into the gearbox or directly into the generator 214.

A shaft which is somewhat smaller than the main shaft, such as a shaft 220 transferring the torque from the gearbox to the generator, is also illustrated in the figure and held in place and supported by bearings 204.

For another shaft of the WTG, such as the somewhat smaller shaft 220, an rpm of the somewhat smaller shaft 220 may be in the interval 800-2400 rpm. A frequency of the vibrations of the shaft 220 may be in the interval from a few Hz to a few hundred Hz.

A vibration damper for actively damping vibrations of a WTG shaft is shown positioned around the main shaft 208 and provided to actively dampen vibrations of the main shaft, but the damper and embodiments hereof as described herein may alternatively or additionally be used for the somewhat smaller shaft 220.

Electromagnets 222 of an active vibration damper for actively damping vibrations of a WTG shaft, in the shown example the main shaft 208, are positioned around the shaft in the middle or substantially in the middle of the longitudinal distance between the shaft bearings 202. In the shown example, four electromagnets are positioned adjacent to a periphery of the shaft in a ring form around the shaft, though only three electromagnets are visible due to the shaft. A damper includes at least one vibration sensor 224 adapted to provide a vibration signal in response to the vibrations of the WTG shaft. In FIGS. 2 and 3 two vibration sensors 224 are illustrated.

A reason for this position of the damper may be that radial vibrations of the shaft may have largest amplitude in the middle or substantially in the middle of the length of the shaft 208. Alternatively, a plurality of dampers may be positioned along a longitudinal extension of the shaft to be dampened. As an example two dampers may be positioned along the shaft, one adjacent to each of the bearings for the shaft. Alternatively, one or more sets of electromagnets, possibly positioned in a ring, may be positioned along the length of the shaft, such as a ring of electromagnets adjacent to each of the bearings for the shaft and a ring of electromagnets or one or more sets of electromagnets in the middle or substantially in the middle of the shaft.

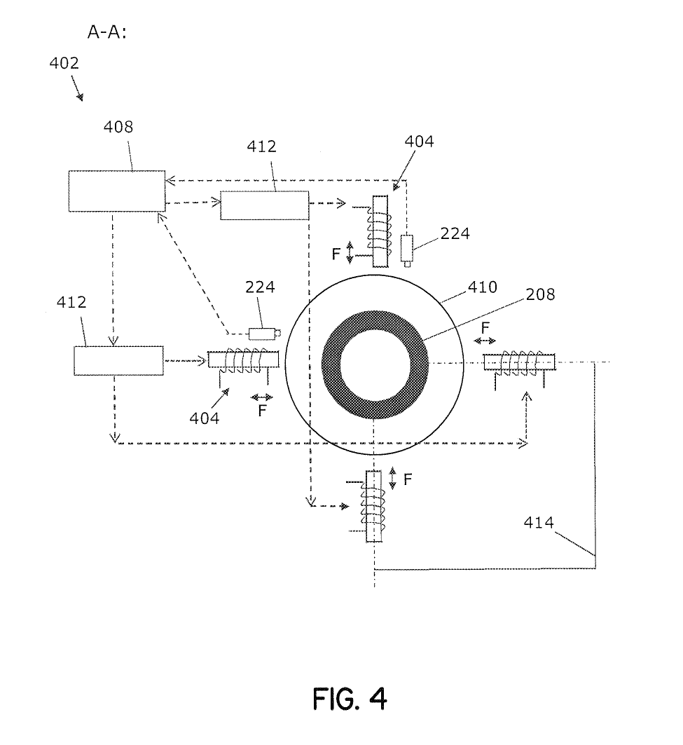

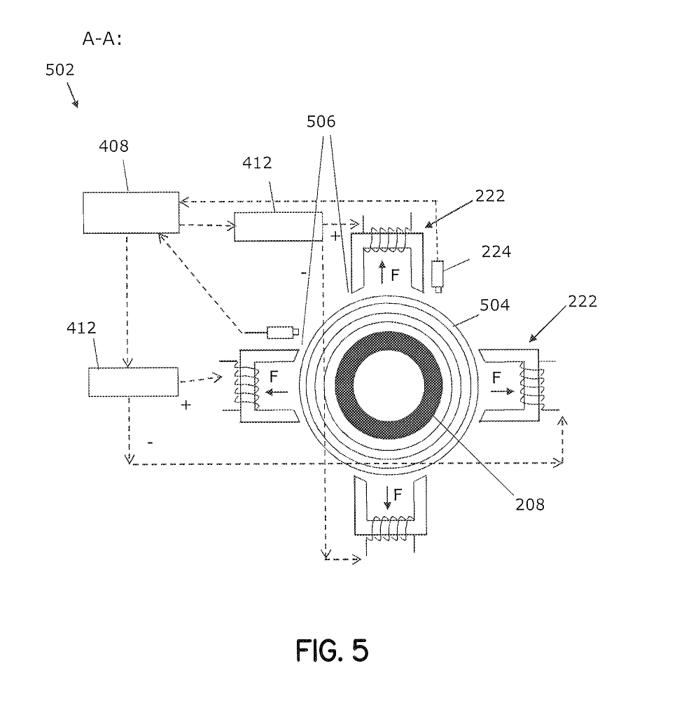

FIG. 3 is the illustration of the drive train 304 of the WT of FIGS. 1 and 2 including an active vibration damper. WT parts, such as the nacelle and tower, shown in FIG. 2 are not shown in FIG. 3. At 302 the figure indicates a position and direction of a cross-sectional view A-A adjacent to the electromagnets of the vibration damper, perpendicular to the longitudinal direction of the shaft and to be seen in a direction towards the electromagnets. The cross-sectional view A-A is illustrated and described in the following FIGS. 4 and 5.

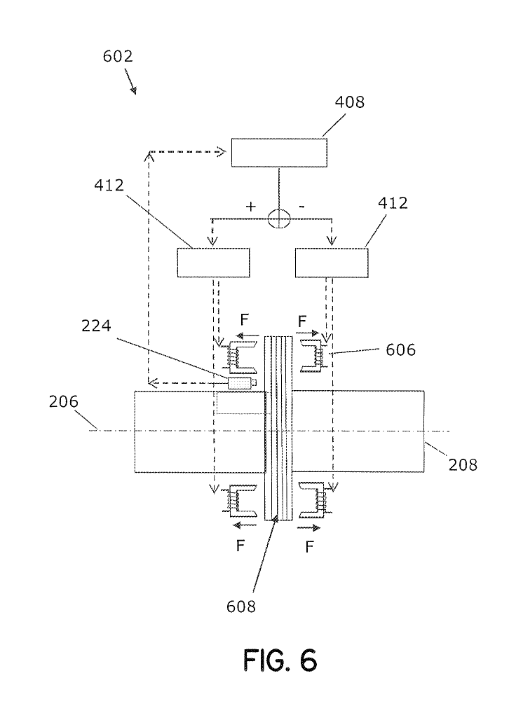

Each of FIGS. 4-6 shows an embodiment of a vibration damper 402, 502 and 602, respectively. The various embodiments may be combined. An example of a combination is to provide a shaft of a WTG with one or more dampers for damping radial vibrations of the shaft as described and illustrated in FIG. 4 and/or FIG. 5 and possibly also provide the shaft with at least one of the damper for damping axial vibrations of the shaft as shown and described in FIG. 6. Each of the figures shows an embodiment of the vibration damper 402, 502 and 602, respectively, for actively damping vibrations of the WTG main shaft 208. A damper includes at least one vibration sensor 224 adapted to provide a vibration signal in response to the vibrations of the WTG shaft and at least one electromagnet 222, 404, 606 adapted to provide an electromagnetic force to the WTG shaft.

In order to control and provide active damping of the WTG shaft, the damper includes a controller 408 which controller receives input from the vibration sensor and is operably coupled to the electromagnet and adapted to generate command control signals to the electromagnet. Alternatively, the command signals are provided to a device, such as a power amplifier 412 or, as an example, one or more power switches which are operably coupled to the electromagnet. The power amplifier or the one or more power switches then provides the drive current, which may be varying in current level in response to the vibrations or which may be provided for a varying number of electromagnets (when more than one electromagnet is present). Possibly the drive current is sometimes sent to some electromagnets and sometimes to other electromagnets, this depending, among other things, on the control scheme used and the vibrations sensed.

The control signals are provided as a response to the vibration signal and adjusted by the controller in accordance with a suitable control scheme for the electromagnet 222, 404 or 606 to provide an electromagnetic force to the shaft 208 and hereby dampen the vibrations of the shaft 208, relative to the bearings 202 and/or the supporting structure 218 and/or relative to the fixed and substantially non-vibrating position of the vibration sensor 224. The shaft 208 may comprise a material which is reactive to the provided electromagnetic force or such a material can be attached to the shaft.

The vibration sensor 224 is adapted to provide a signal which is dependent on the vibrations of the shaft, such as a signal which is continuously dependent on the distance between the sensor and the shaft. From the signal a frequency and/or a magnitude of the vibrations may be provided. Alternatively or additionally, the vibration sensor senses an outputted force by the vibrations, and the controller issues control commands to one or more selected electromagnets in response to the resulting force of the vibrations so as to actively suppress the vibration of the shaft. A direction of the vibrations can be determined by knowing the position of the vibration sensor 224, and consequently appropriate command signals can be provided to one or more selected electromagnets with suitable fixed positions for suppressing the vibration of the rotating shaft.

The sensor 224 in the shown embodiments is a proximity sensor. When, in response to the vibrations sensed by the sensor and the electromagnet 222, 404 or 606, the controller issues control commands to one or more elected electromagnets placed at one or more positions along or around the shaft to be dampened, an electromagnetic force is applied to the shaft, and active damping of vibrations of the shaft 208 is provided. The damping is relative to the fixed position of the sensor or, for example, a shaft bearing 202 as shown in FIG. 2.

The frequency of radial and/or axial vibrations in the main shaft 208 of a WTG is typically in the interval between 0 and a few hundred Hertz. The magnitude of the vibrations may be in the interval between 0 and a few millimetres, though magnitudes above approximately one millimetre are rare, and if present they are due to a situation out of the ordinary.

The damper shown can be an accessory or add-on to the bearings 202 shown in FIGS. 2 and 3, and thus the purpose of the damper is not to transfer the major radial or axial loads experienced by the bearing 202. Moreover the purpose of the damper 402, 502 or 602 is to suppress the vibration disturbances occurring on the shaft-bearing system. The damper can be provided as a kit to be added to existing wind turbine generators and may also be a built-in part of new WTG drive trains.

The damper 402, 502, 602 can be applied to a non-metallic shaft, such as a composite shaft, through bonding a metallic ring on the shaft or by bonding a metallic coating to the shaft at positions on the shaft adjacent to where the one or more electromagnets 222, 404 or 606 are positioned. The distance between the electromagnet and the shaft should preferably be minimised, and possibly a fluid with a magnetic permeability is filled and held in a place in-between the proposed damper device and the shaft so as to additionally provide a passive vibration effect and/or to decrease a loss in the strength of the magnetic field lines in a gap between the electromagnet and the shaft. Still further, such magnetic oil may have a cooling effect to the electromagnet.

In FIGS. 4, 5 and 6 the vibration damper includes four electromagnets which are positioned in a 90 degree angle 414 from each other as indicated on FIG. 4.

Alternatively, a damper may comprise only one electromagnet and one vibration sensor, though in order to provide improved damping of vibrations in various directions, further electromagnets can be provided as illustrated in the figures.

For example, a pair of electromagnets can be provided. An electromagnet in the pair of electromagnets is positioned 180 degrees opposite to the other electromagnet, and each pair possibly includes a vibration sensor 224 which senses the vibrations of the shaft in a direction which is known, relative to a line between the positions of the electromagnets.

As illustrated in FIGS. 4, 5 and 6, the electromagnets can each be provided by a coil provided around a ferromagnetic piece of material. The wiring or signal directions shown with dashed lines in the figures are for illustration purposes only, and some wiring and signal lines or directions, such as return wiring for currents running through the coils, are for simplicity and as an example, not shown. The signals from the sensors may be sent in wires or may, alternatively and as an example, be provided wirelessly. For illustration purposes, the controller is shown as present near the sensors, etc., but the controller may be positioned elsewhere, such as remote from the sensor and electromagnets, such as in a main controller (not shown) of the WT or even of a WTG park in which the WT is placed. Alternatively, no separate controller is needed for the damper and control functions; memory and/or processor power within such main controller which is already present can be accessed and used instead.

FIG. 4 illustrates an embodiment of a vibration damper with four single pole electromagnets. The electromagnets are arranged so as to apply an electromagnetic force F, as shown on the figure with an ‘F’ and a line with an arrow in both ends, which force F may push or attract the WTG shaft in a radial direction of the shaft, relative to each of the electromagnets. The shaft is adapted so as to be permanently magnetic or a permanently magnetic material is attached to the shaft. The ensuing direction of the force F applied by the electromagnet 404 and 222 in FIGS. 4 and 5 is radial to the shaft and thus directly or substantially directed towards or away from the magnetic reactive material of the shaft 208 or of a magnetic reactive material attached to the shaft.

FIG. 5 illustrates an embodiment of a vibration damper with four dual pole electromagnets 222 positioned so as to enable induction of an electromagnetic force F, which force attracts the WTG shaft in a radial direction of the shaft towards the electromagnet. The shaft 208 comprises a ferromagnetic laminated stack 504 attached to the shaft to provide the magnetic flux path and hereby the magnetic forces while minimizing eddy current formation.

In the shown embodiment, the coils of the electromagnets as well as the currents running through the coils are adapted, provided and arranged such that opposite poles are adjacent, maximizing magnetic flux through the rotor. Two proximity or position sensors are positioned perpendicular to each other and are used to detect the relative vibration of the shaft in these two perpendicular directions, and the signals are sent to the controller 408.

The controller uses the sensor signals to generate the command signals which drive the power amplifiers 412 to provide current output to one or more selected coils and thereby provide a suitable electromagnetic force F or varying force F or a resulting force with varying direction, for example, resulting from use of multiple electromagnets, to the shaft. Through a suitable control scheme, such as using velocity feedback, the vibration of the shaft can thereby be effectively attenuated.

FIG. 6 is an illustration of an embodiment of a vibration damper. FIG. 6 is a top view along a part of the shaft 208. In this embodiment, a magnetic material of the shaft, or attached to the shaft, and the electromagnet 606 is provided and positioned so as to apply an electromagnetic force to the WTG shaft in an axial direction of the shaft and thereby dampen vibrations of the shaft in the axial or longitudinal direction of the shaft 208.

In the shown embodiment, the magnetic reactive material is extending 90 degrees from the shaft 208 and is provided as a ferromagnetic laminated stack with layers in a ring-formed stack. The layers 608 are provided one on top of each other in the axial direction of the shaft. A force applied by the electromagnet 606 has a resulting direction in the axial direction of the shaft and thus perpendicular to the magnetic reactive material extending from the shaft 208.

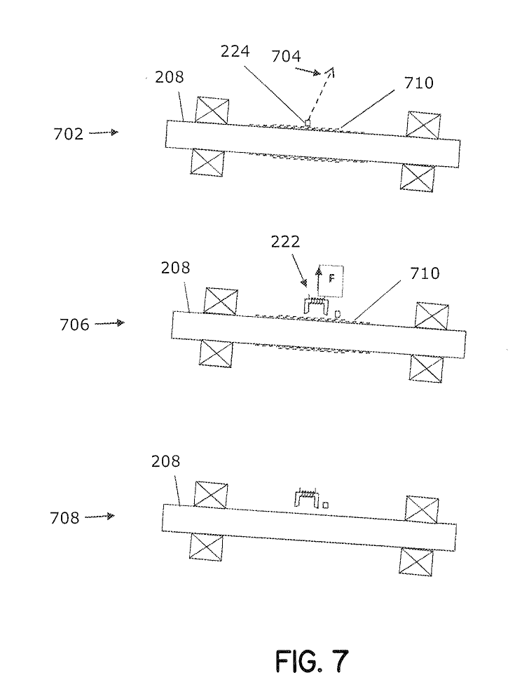

FIG. 7 illustrates a method of actively damping vibrations 710 in a shaft of a WTG. For illustration purposes, the magnitude of the vibrations, and thus the size of displacement of the shaft due to the vibrations, are exaggerated in the figure. A method of actively damping vibrations in a shaft of a WTG is illustrated, which method includes sensing 702 vibrations of the WTG shaft 208 and providing 704 a vibration signal in response to the vibrations. Furthermore, the figure illustrates providing command signals in order to provide a drive current to an electromagnet 222 in response to the vibration signal and applying 706 a electromagnetic force F to the shaft 208, such as in counter phase with the vibrations or moreover the direction of the vibrations, with the electromagnet 222. Thereby, the vibrations of the shaft are dampened, controlled or counteracted.

The vibration sensor can be a proximity sensor which detects the vibration of the shaft, and the vibration signal is continuously sent to the controller 412 in real time. The controller uses the vibration signal and a control scheme or algorithm, which can be a velocity feedback control scheme, or a PID control scheme, or an n-th order filter control scheme, or any other suitable control scheme, to generate one or more output command signals to be sent to the one or more amplifiers 412, and regulate the amplifiers to send changing current or a possibly changing drive signal to an amplifier, possibly in order to provide changing current to one or more selected electromagnets. A changing current will cause change of the electromagnetic field, which then generates the electromagnetic force on the shaft to control, dampen, attenuate, suppress or counteract the vibrations of the shaft 208.

In short, it is herein disclosed that in order to provide, among other things, a damper 402, 502, 602 which effectively dampen vibrations 710 experienced by a shaft 208, 220 in a drive train 304 of a wind turbine generator 102, such as a main shaft 208 of the WTG, there is disclosed a vibration damper for damping vibrations of the WTG shaft. The damper comprises a vibration sensor 224 adapted to provide a vibration signal in response to the vibrations of the shaft, and an electromagnet 222, 404, 606 adapted to provide an electromagnetic force to the shaft and a controller 408 operably coupled to the vibration sensor and the electromagnet and adapted to generate command signals to provide suitable drive current to the electromagnet, in response to the vibration signal, and for the electromagnet to provide an electromagnetic force to the shaft and hereby actively dampen the vibrations of the shaft.

As will be appreciated by one skilled in the art, embodiments of the invention may be embodied as a system, method, or computer program product embodied in any tangible machine-readable or computer-readable storage medium with computer-usable program code embodied therein. A person of ordinary skill in the art will appreciate that the various embodiments of the invention are capable of being distributed as a computer program product in a variety of forms. Examples of machine-readable storage medium include, but are not limited to, tangible, recordable type media such as volatile and non-volatile memory devices, floppy and other removable disks, hard disk drives, magnetic tape, and optical disks (e.g., CD-ROMs, DVDs, etc.), as well as transmission type media like analog and digital communication links.

The controller may include at least one processor coupled to a memory, which may represent the random access memory (RAM) devices constituting the main storage of the computer and any cache memories, non-volatile or backup memories (e.g. programmable or flash memories), read-only memories, etc. The controller may also include a mass storage device, one or more user input devices, and/or a display, as well as an interface for external communications. The controller generally operates under the control of an operating system, and executes or otherwise relies upon various computer software applications, components, programs, objects, modules, data structures, etc., such as the control scheme or algorithm described herein.

Although the present invention has been described in connection with preferred embodiments, it is not intended to be limited to the specific form set forth herein. Rather, the scope of the present invention is limited only by the accompanying claims.

In this section, certain specific details of the disclosed embodiment are set forth for purposes of explanation rather than limitation, so as to provide a clear and thorough understanding of the present invention. However, it should be understood readily by those skilled in this art that the present invention may be practised in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality.

What is claimed is:

1. A vibration damper for damping vibrations of a WTG shaft, comprising:
at least one vibration sensor adapted to provide a vibration signal in response to the vibrations of the shaft,
at least one electromagnet adapted to provide an electromagnetic force to the shaft, and
a controller operably coupled to the electromagnet and adapted to generate a command signal in order to provide a drive current for the electromagnet in response to the vibration signal, and in order for the electromagnet to provide an electromagnetic force to the shaft and thereby dampen the vibrations of the shaft.

2. The vibration damper according to claim 1, wherein the damper comprises at least two electromagnets and the electromagnets are positioned 90 degrees or substantially 90 degrees from each other.

3. The vibration damper according to claim 1, wherein the damper comprises at least one pair of two electromagnets, and the two electromagnets in the pair are positioned 180 degrees or substantially 180 degrees from each other.

4. The vibration damper according to claim 1, wherein the at least one electromagnet is a dual pole electromagnet.

5. The vibration damper according to claim 4, wherein adjacent poles of individual dual pole electromagnets are arranged with opposite polarity.

6. The vibration damper according to claim 1, wherein the at least one electromagnet is a single pole electromagnet.

7. The vibration damper according to claim 1, wherein the vibration sensor is a sensor for sensing a relative displacement of the shaft compared to another part of the WTG.

8. The vibration damper according to claim 1, wherein the vibration sensor is adapted to provide a signal from which signal a frequency and/or a magnitude of the vibrations can be provided.

9. The vibration damper according to claim 1, wherein the vibration sensor is a proximity sensor.

10. A WTG comprising a vibration damper according to claim 1 and a shaft, which shaft comprises a material that is reactive to the provided electromagnetic force.

11. A WTG comprising a vibration damper according to claim 1 and a shaft, which shaft comprises a ferromagnetic laminated stack attached to the shaft.

12. The WTG according to claim 10, wherein the at least one electromagnet of the vibration damper is positioned so as to apply an electromagnetic force to the WTG shaft in a radial direction of the shaft.

13. The WTG according to claim 10, wherein the at least one electromagnet of the vibration damper is positioned so as to apply an electromagnetic force to the WTG shaft in an axial direction of the shaft.

14. A method of actively damping vibrations in a shaft of a WTG, comprising:
sensing vibrations of the shaft and providing a vibration signal in response to the vibrations,
providing a command signal in response to the vibration signal in order to provide a drive current for the electromagnet in response to the vibrations, and thereby
applying an electromagnetic force to the shaft with the electromagnet and in response to the vibration signal, and
damping the vibrations of the shaft by applying the electromagnetic force to the shaft.

15. The method of actively damping vibrations in a shaft of a WTG according to claim 14, wherein at least one of a magnitude, a direction, and a frequency of the electromagnetic force is varied in response to varying vibrations.

16. A computer program product, when running on a computing device, being adapted to perform the method of claim 14.
